(19) United States
(12) Patent Application Publication
(10) Pub. No.: US 2004/0085205 A1
(43) Pub. Date: May 6, 2004

(54) Monitor system with video and audio transmission actuated by doorbell actuator

(76) Inventor: Jacob Yeh, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/284,328

(22) Filed: Oct. 31, 2002

(51) Int. Cl. G08B 21/00

(52) U.S. Cl. 340/540; 379/159

(57) ABSTRACT

A monitor system includes an outdoor doorbell module integrated with video and audio transmission, an indoor remote receiver and a signal transmission interface. The doorbell module includes a depressible button and a micro-camera and a sound detector actuated by the button to obtain visual image and sounds of the visitor. The remote receiver includes a signal receiver circuit to receive the doorbell actuation signal and the visual image and sounds from the doorbell module, an alarm generator activated by the doorbell actuation signal to ring, and a driver circuit generating control signals to control a monitoring device and a recording device. When the button is actuated by the visitor, the remote receiver receives the doorbell actuation signal and generates the ring. At the same time, the doorbell module activates the micro-camera and the sound detector to obtain visual image and sounds of the visitor. The visual image and sounds are transmitted to the remote receiver and then displayed by the monitoring device and selectively recorded by the recording device.

### BACKGROUND OF THE INVENTION

1. Field of the Invention

The present invention relates generally to a household security monitor system, and in particular to a security monitor system integrated with a doorbell system for automatic transmission of visual images and sounds of a visitor when the doorbell is actuated.

2. The Related Art

Conventionally, a doorbell system comprises an actuation button mounted outside a house or an apartment next to a main entrance of the house. The actuation button is connected to an electronic bell or a buzzer whereby when the actuation button is pressed by a visitor, the electronic bell or buzzer is actuated to ring, such as a rhythm of music or buzzing, to notify the host of the arrival of the visitor. The conventional connection between the actuation pushbutton and the electronic bell is done by wires, which leads to certain troubles in installing the doorbell system. Thus, wireless doorbell systems are also available in the market wherein the actuation of the outdoor button is transmitted to a receiver of the electronic bell in a wireless manner. This solves the troubles of installing wires connecting between the button and the electronic bell.

However, both wired and wireless types suffer security problems. For example, the house host cannot identify the visitor by simply listening to the sounds generated by the doorbell system. The host must visually observe the visitor in one way or the other in order to clearly identify the visitor. Often, the host slightly opens the door in order to see the visitor. This may be dangerous for it gives a burglar a chance to force in the house. Besides such a problem, a thief may test the host by simply actuating the button. If no one answers, then the thief can be quite sure that there is nobody home. All these problems are the drawbacks of the conventional doorbell systems.

To allow for visual identification of the visitor, some use an additional video camera to view the visitor. However, the video camera is an expensive device.

Thus, it is desired to have a security monitor system integrated with a doorbell system for overcoming the above problems.

### SUMMARY OF THE INVENTION

Thus, an object of the present invention is to provide a doorbell system incorporating video and audio transmission for enhanced house security.

Another object of the present invention is to provide a doorbell system incorporating video and audio transmission, the doorbell system being of wireless connection between an outdoor unit and an indoor unit whereby installation is simplified.

A further object of the present invention is to provide a security monitor system having video and audio transmission actuateable by an actuation button of a doorbell system whereby when the doorbell is actuated by a visitor, video and audio signals regarding the visitor actuating the doorbell system are simultaneously transmitted to the monitor system for identification of the visitor.

To achieve the above objects, in accordance with the present invention, there is provided a security monitor system comprising an outdoor doorbell module integrated with video and audio transmission, an indoor remote receiver and a signal transmission interface coupled between the doorbell module and the remote receiver. The doorbell module comprises a depressible button accessible and operable by a visitor and a micro-camera and a sound detector actuated by the button to obtain visual image and sounds of the visitor. The remote receiver comprises a signal receiving circuit coupled to the signal transmission interface to receive the doorbell actuation signal and the visual image and sounds from the doorbell module, a ring generator activated by the doorbell actuation signal to ring, and a driver circuit generating control signals to control a monitoring device and a recording device. When the button is actuated by the visitor, the remote receiver receives the doorbell actuation signal via the signal transmission interface and generates the ring. At the same time, the doorbell module activates the micro-camera and the sound detector to obtain visual image and sounds of the visitor. The visual image and sounds are transmitted through the signal transmission interface to the remote receiver and then displayed by the monitoring device and selectively recorded by the recording device.

### BRIEF DESCRIPTION OF THE DRAWINGS

The present invention will be apparent to those skilled in the art by reading the following description of a preferred embodiment thereof, with reference to the attached drawings, in which:

FIG. 1 is a block diagram of a monitor system constructed in accordance with the present invention;

FIG. 2 is a perspective view showing an outdoor unit of the monitor system of the present invention mounted on a wall;

FIG. 3 is an exploded view of the outdoor unit of the monitor system of the present invention;

FIG. 4 is a cross-sectional view taken along line 4-4 of FIG. 2;

FIG. 5 is a circuit diagram of a control circuit of the outdoor unit of the monitor system in accordance with the present invention;

FIG. 6 is a block diagram of an indoor unit of the monitor system in accordance with the present invention; and

FIG. 7 is a block diagram showing connection between the indoor unit of the monitor system of the present invention and a recording device and a monitoring device.

### DETAILED DESCRIPTION OF PREFERRED EMBODIMENT

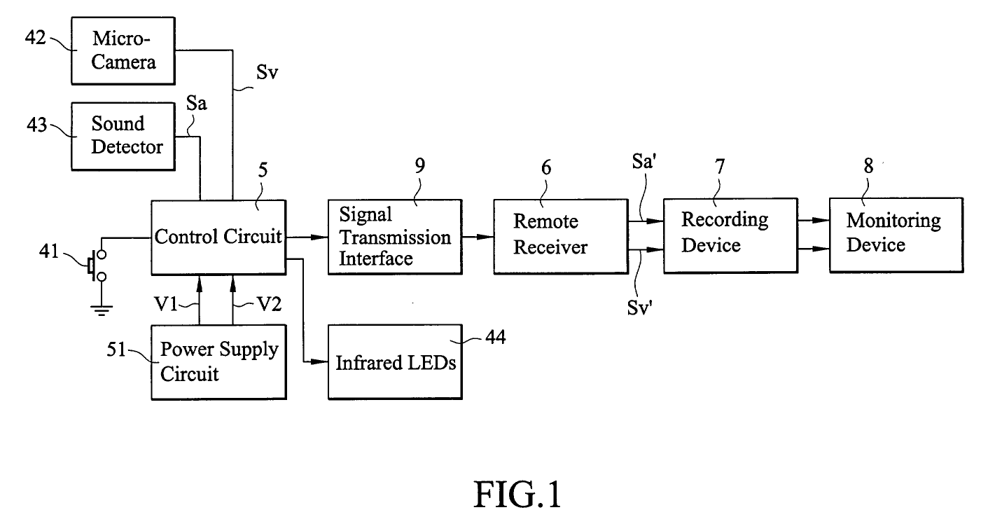

With reference to the drawings and in particular to FIG. 1, a monitor system constructed in accordance with the present invention comprises an outdoor unit comprising a doorbell module 1 integrated with video and audio transmission and an indoor unit comprising a remote receiver 6, a recording device 7, and a monitoring device 8. The doorbell module 1 of the outdoor unit is coupled to the remote receiver 6 of the indoor unit by means of the signal transmission interface 9. Preferably, the signal transmission interface 9 comprises a wireless transmission interface for transmission of signal in a wireless manner.

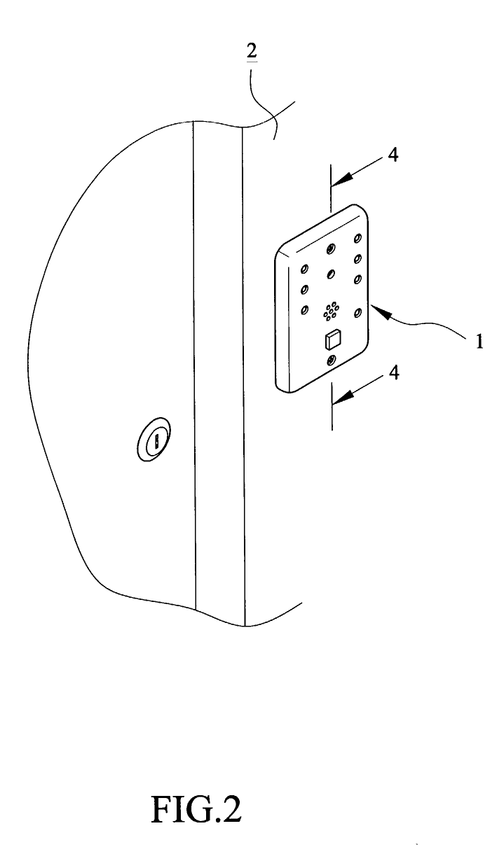

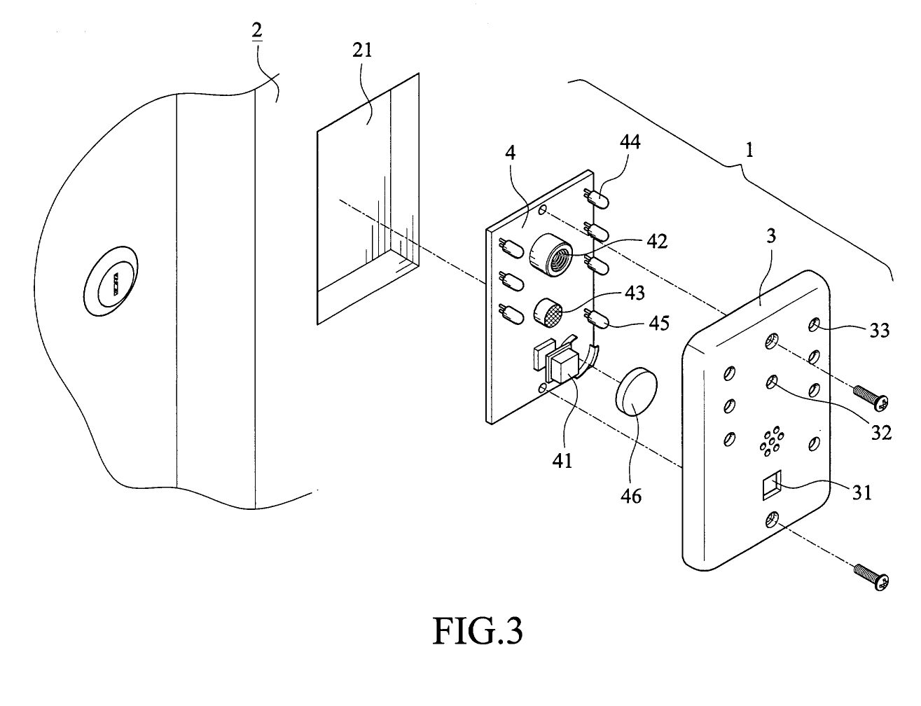

The doorbell module 1 is located outdoors and mounted to a fixture outside a house, such as a wall, while the remote receiver 6 is located indoors at a location within an effective signal receiving distance of the wireless signal transmission. FIGS. 2 and 3 show an example of the doorbell module 1 mounted to an outdoor wall 2. Preferably, the doorbell module 1 is received in a box 21 that is fixed in the wall 2. Alternatively, the doorbell module 1 is positioned in a recess or cavity (not shown) formed in the wall 2.

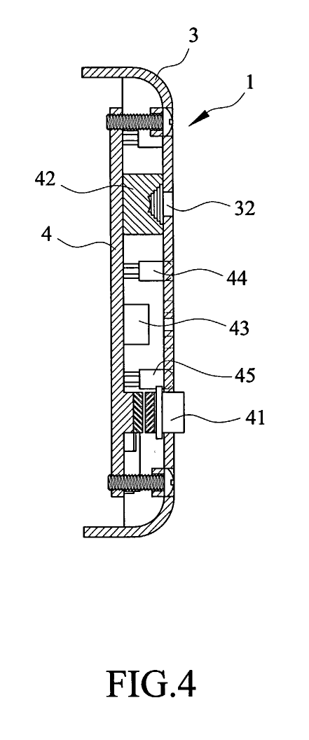

Also referring to FIG. 4, the doorbell module 1 comprises a case 3 defining an interior space (not labeled) in which a circuit board 4 is fixed. A depressible actuation button 41 is mounted on the circuit board 4 and extends outside the case 3 through an opening 31 defined in the case 3 for the access of a visitor.

A micro-camera 42 is mounted to the circuit board 4 and is positioned in alignment with a hole 32 defined in the case 3 for photographing the visitor. A sound detector 43, such as a microphone, is mounted on the circuit board 4 for detecting sounds of the visitor and outside.

A plurality of infrared light emitting diodes (LEDs) 44 are mounted on the circuit board 4 and arranged in alignment with holes 33 defined in the case 3 for projecting infrared light through the holes 33 toward an object in front of the case 3 or the visitor. The infrared light illuminates the object or the visitor and provides required luminance for the micro-camera 42 to take picture in a dark condition. An indicator 45 is provided on the circuit board 4 for indication of operation condition of a power unit 46, such as a rechargeable battery cell.

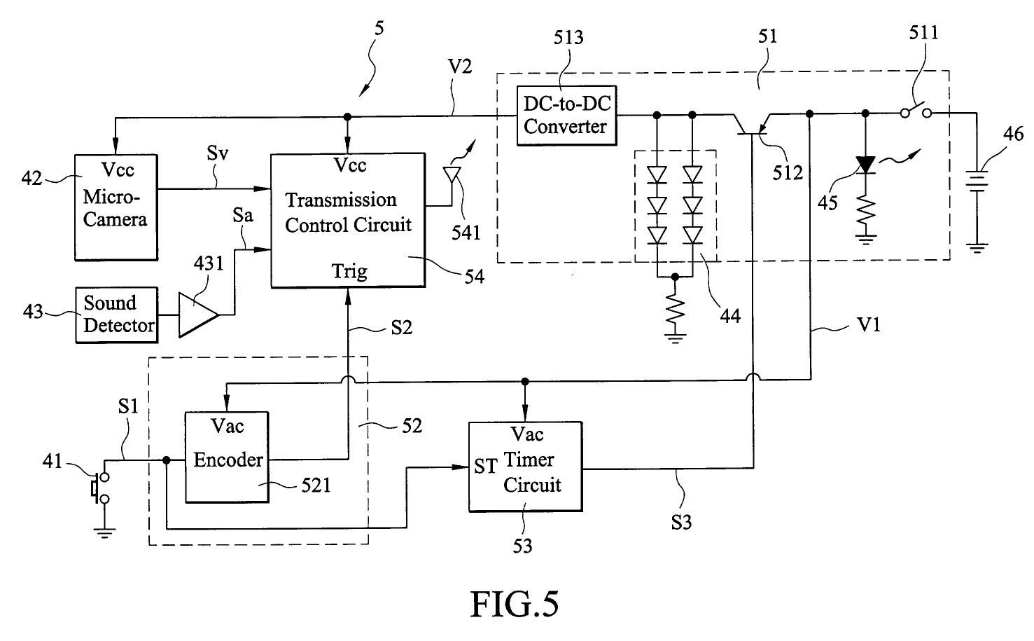

Also referring to FIG. 5, the circuit board 4 comprises a control circuit 5 comprised of a power supply circuit 51, a triggering circuit 52, a timer circuit 53 and a transmission control circuit 54.

The power supply circuit 51 comprises a first power supply circuitry for supplying a first voltage V1 to the triggering circuit 52 and the timer circuit 53. The first voltage V1 is supplied from the battery cell 46 via a power switch 511 and is continuously and constantly applied to power terminals Vac of the triggering circuit 52 and the timer circuit 53.

The power supply circuit 51 further comprises a second power supply circuitry for supplying a second voltage V2 to the transmission control circuit 54, the micro-camera 42 and sound detector 43. The second voltage V2 is supplied from the battery cell 46 via the power switch 511 and is further transmitted through a switching element 512, such as a transistor, and a DC-to-DC converter 513 that are connected in series to the power switch 511 for application to power terminals Vcc of the transmission control circuit 54, the micro-camera 42 and the sound detector 43.

The triggering circuit 52 comprises an encoder 521 having an input terminal connected to the actuation button 41 for receiving an actuation signal SI from the actuation button 41 when the button 41 is actuated. The actuation signal S1 is encoded by the encoder 521 to form an encoded triggering signal S2, which is then applied to a triggering terminal Trig of the transmission control circuit 54.

The timer circuit 53 has a starting terminal ST connected to the button 41. Thus, when the button 41 is actuated and the actuation signal S1 is generated and transmitted to the timer circuit 53, the timer 53 starts a timing operation and generates a timing control signal S3 to the switching element 512 to turn on the switching element 512. The second voltage V2 is thus allowed to apply to the transmission control circuit 54, the micro-camera 42 and the sound detector 43. The timer circuit 53 maintains the switching element 512 on until the timing operation reaches a predetermined period of time, such as one minute, and at that moment the timer circuit 53 turns off the switching element 512. The supply of the second voltage V2 to the transmission control circuit 54, the micro-camera 42 and the sound detector 43 is thus cut off.

The micro-camera 42 and the sound detector 43 are connected to the transmission control circuit 54 for applying video signal Sv and audio signal Sa captured by the micro-camera 42 and the sound detector 43 to the transmission control circuit 54. The audio signal Sa from the sound detector 43 is processed by an amplifier 431 before being applied to the transmission control circuit 54. The transmission control circuit 54 comprises an antenna 541. The triggering signal S2 from the encoder 521, the video signal Sv of the micro-camera 42 and the audio signal Sa of the sound detector 43 that are applied to the transmission control circuit 54 are processed by the transmission control circuit 54 and transmitted through the antenna 541.

Thus, when the actuation button 41 is actuated to generate the actuation signal S1, the timer circuit 53 starts a timing operation for a predetermined period of time which allows for the supply of the second voltage V2 to the transmission control circuit 54, the micro-camera 42 and the sound detector 43 for that period of time. The signals Sv and Sa from the micro-camera 42 and the sound detector 43 are applied to the transmission control circuit 54 and transmitted to the indoor unit via the antenna 541.

The remote receiver 6 of the indoor unit receives the video signal Sv, the audio signal Sa and the triggering signal S2 from the antenna 541 and supply these signals that are indicated by reference numerals Sv′, Sa′ and S2′ for distinction to the recording device 7 and a decoder 63. Thus, besides buzzing sound that is provided by the conventional doorbell, visual image and sounds of the visitor can also be obtained through the outdoor unit.

When the surrounding illumination around the outdoor unit is dimming off and getting lower than a predetermined threshold level, the infrared light given off by the infrared LEDs 44 enhances picturing an object in front of the outdoor unit, such as a visitor, by the micro-camera 42.

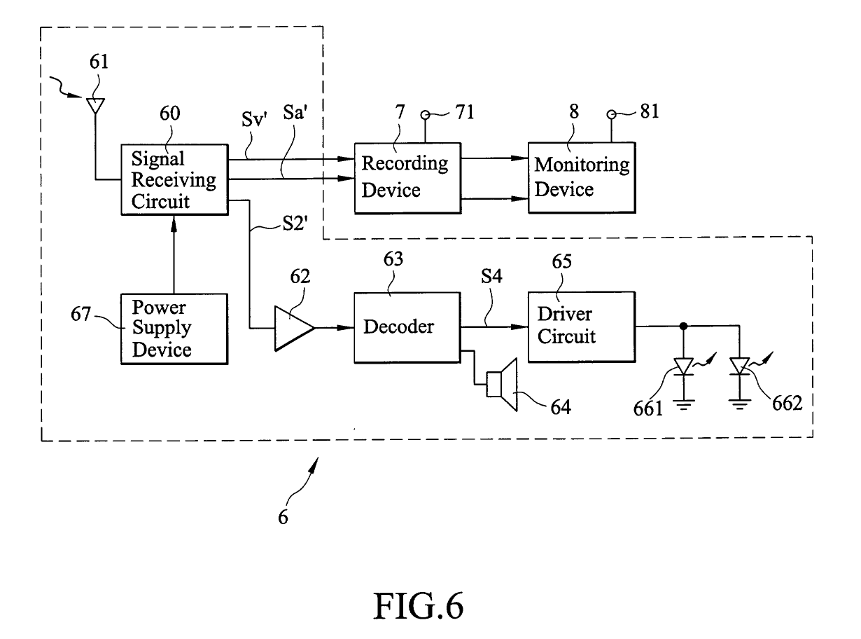

Also referring to FIG. 6, the remote receiver 6 comprises a signal receiving circuit 60 having an antenna 61 for receiving the signals from the antenna 541 of the transmission control circuit 54 of the outdoor doorbell module 1. The signal receiving circuit 60 processes the received signals and provides corresponding video and audio signals Sv′ and Sa′ via a cable (not shown) to the recording device 7 that makes chronic records of the signals received. A monitoring device 8, such as a television set, is coupled to the recording device 7 for displaying and broadcasting the received signals Sv′ and Sa′.

The triggering signal that is received and processed by the signal receiving circuit 60 is indicated by reference numeral S2′ and is applied to an amplifier 62. The output of the amplifier 62 is transmitted to the decoder 63 for decoding and identification of the signal S2′. If the received signal S2′ is not transmitted from the doorbell module 1, then the signal is simply neglected. If the signal S2′ is identified to be a proper signal from the doorbell module 1, then a sound generator, such as speaker and a buzzer, is actuated to give off a ring, for example a rhythm of music or buzzing, to indicate of the arrival of the visitor. At the same time, the decoder 63 sends a driver signal S4 to a driver circuit 65 that drives first and second infrared light emitting elements 661, 662 to generate remote control signals. Such remote control signals are received by the infrared remote control signal receivers 71, 81 of the recording device 7 and the monitoring device 8 for starting up and shutting off the recording device 7 and the monitoring device 8.

The remote receiver 6 is powered by a working voltage that is supplied from a power supply device 67. The power supply device 67 can be a battery cell or an adapter connected to an electric power source.

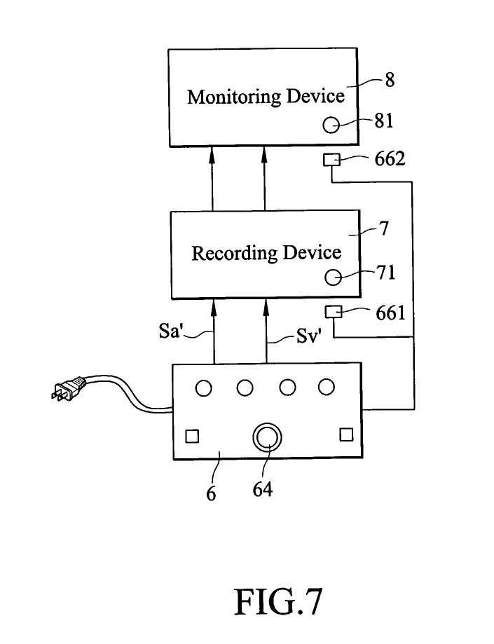

FIG. 7 shows the connection between the remote receiver 6, the recording device 7 and the monitoring device 8. The first infrared light-emitting element 661 is located close to the infrared remote control signal receiver 71 of the recording device 7 for effectively controlling the operation of the recording device 7. The second light-emitting element 662 is located close to the infrared remote control signal receiver 81 of the monitoring device 8 for effectively controlling the operation of the monitoring device 8.

By means of integration of the doorbell module 1 that is capable to capture video and audio signals with the remote receiver 6, the doorbell system is capable of more than ringing representing the actuation of the doorbell by providing visual image and sounds of a visitor actuating the doorbell to an indoor monitoring device. The capturing and transmission of the visual image and sounds are automatically activated by the actuation of the doorbell button. In addition, the visual image and sounds can be selectively recorded for later reviewing.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A monitor system comprising:
a doorbell module comprising:
a manually operable actuator for selectively generating an actuation signal,
a micro-camera operable to capture visual image and generate a video signal corresponding to the visual image,
a sound detector operable to receive external sounds and generating an audio signal corresponding to the external sounds, and
a control circuit to which the actuator is mounted, the control circuit generating a triggering signal in response to the actuation signal from the actuator and activating the operation of the camera and the sound detector, the control circuit receiving the video and audio signals from the camera and the sound detector;
a signal transmission interface comprising a first portion coupled to the doorbell module for receiving the triggering signal and the video and audio signals from the control circuit and transmitting the signals toward a second portion; and
a remote receiver to which the second portion of the signal transmission interface is coupled, the remote receiver comprising:
a signal receiving circuit receiving the triggering signal, the video signal and the audio signal from the second portion of the signal transmission interface,
a sound generator connected to the signal receiving circuit for generating a ring in response to the triggering signal,
a driver connected to the signal receiving circuit for generating at least one control signal in response to the triggering signal, and
video/audio means receiving the video and audio signals from the signal receiving circuit and operable by the control signal to display the video and audio signals.

2. The monitor system as claimed in claim 1, wherein the signal transmission interface comprises a wireless transmission between the first and second portions.

3. The monitor system as claimed in claim 1, wherein the control circuit of the doorbell module comprising:
a triggering circuit comprising the actuator for generating the triggering signal in response to the actuation signal caused by the operation of the actuator;
a transmission control circuit to which the camera and the sound detector are connected for receiving the video signal and the audio signal; and
a power supply circuit supplying a working voltage to the doorbell module;
wherein the transmission control circuit is coupled to the first portion of the transmission interface for transmitting the video and audio signals and the triggering signal in response to the triggering signal, and when the actuator is actuated to generate a triggering signal to the transmission control circuit, the transmission control circuit processes and transmits the triggering signal, the video signal of the micro-camera and the audio signal of the sound detector to the signal transmission interface.

4. The monitor system as claimed in claim 3, wherein the power supply circuit comprises a first voltage supply circuitry for supplying a first voltage continuously and constantly to the triggering circuit and a second voltage supply circuitry comprised of a switching element for selectively supplying a second voltage to the transmission control circuit, the camera and the sound detector.

5. The monitor system as claimed in claim 4, wherein the switching element is controlled by a timer circuit to selectively supply the second voltage to the transmission control circuit, the camera and the sound detector, the timer circuit being coupled to the actuator and controlled thereby to close the switching element for a predetermined period of time in response to the operation of the actuator.

6. The monitor system as claimed in claim 1, wherein the doorbell module further comprises a plurality of infrared light emitting diodes for generating an infrared light to enhance picturing of the camera.

7. The monitor system as claimed in claim 1, wherein the video/audio means comprises a recording device connected to the remote receiver for recording the video and audio signals.

8. The monitor system as claimed in claim 1, wherein the video/audio means comprises a monitoring device for displaying the video and audio signals.

9. The monitor system as claimed in claim 1, wherein the driver of the remote receiver comprises an infrared light-emitting element for giving off an infrared light as the control signal.

10. A doorbell module comprising:
a case defining an interior space;
a circuit board fixed in the interior space;
a manually operable actuator mounted on the circuit board and extending outside the case through an opening defined in the case for being accessed to selectively generate an actuation signal;
a camera mounted to the circuit board in alignment with a hole defined in the case to capture visual image and generate a video signal corresponding to the visual image;
a sound detector mounted to the circuit board to receive external sound and generate an audio signal corresponding to the external sound, and
a control circuit formed on the circuit board and connected to the actuator for receiving the actuation signal and in response to the actuation signal, activating the camera and the sound detector and receiving and transmitting the video and audio signals.

11. The doorbell module as claimed in claim 10 further comprising illuminating elements mounted on the circuit board and controlled by the control circuit to give off light for enhancing picturing operation of the camera.

12. The doorbell module as claimed in claim 11, wherein the illuminating elements comprise infrared light emitting diodes.
